(19) United States
(12) Patent Application Publication
(10) Pub. No.: US 2024/0196373 A1
(43) Pub. Date: Jun. 13, 2024

(54) RESOURCE MANAGEMENT FOR ULTRA-RELIABLE LOW LATENCY COMMUNICATIONS (URLLC)

(71) Applicant: Verizon Patent and Licensing Inc., Basking Ridge, NJ (US)

(72) Inventors: Jay J. Lee, San Ramon, CA (US); Taher Farkhondeh, Danville, CA (US)

(21) Appl. No.: 18/065,144

(22) Filed: Dec. 13, 2022

(51) Int. Cl. H04W 72/02; H04L 5/00; H04W 72/0446; H04W 72/0457; H04W 72/512

(52) U.S. Cl. CPC H04W 72/02; H04L 5/0012; H04W 72/0446; H04W 72/0457; H04W 72/512

(57) ABSTRACT

Systems and methods described herein provide optimized resource management to meet Ultra-Reliable Low-Latency Communications (URLLC) service requirements in Radio Access Networks (RANs), such as Fifth Generation New Radio (5G-NR) RANs. A network device stores resource management policy options for implementing communication sessions for a URLLC service level and determines that the URLLC service level is required for a communication session requested by a user equipment (UE) device. The network device selects one of the resource management policy options for the communication session based on a number of antennas used by an access station supporting the communication session and one of: an estimated available bandwidth for the access station or a transmission delay for processing a packet in the communication session. The network device sends, to the access station, the selected one of the different resource management policy options.

### BACKGROUND

Next generation wireless networks (e.g., Fifth Generation (5G) networks) are intended to provide various services and applications to user devices with optimized latency and quality of service. For example, the use of Multi-access Edge Computing (MEC) platforms with 5G networks allows high network computing loads to be transferred onto edge servers, which can minimize latency and reduce backhaul delay. Ultra-Reliable Low-Latency Communications (URLLC) is a key service category of a 5G system that may be used to support services such as autonomous driving, factory automation, augmented and virtual reality (AR/VR), remote surgery, smart grids, cloud-based gaming, and other services.

### BRIEF DESCRIPTION OF THE DRAWINGS

FIGS. 1 and 2 are diagrams illustrating a network environment according to an implementation described herein;

FIG. 3 is a diagram illustrating example logical components of a Radio Access Network (RAN) intelligent controller, according to an implementation;

FIGS. 4A-4C are diagrams illustrating different resource management policy options for Ultra-Reliable Low-Latency Communications (URLLC), according to an implementation;

FIG. 5 is a diagram illustrating policy selection by a URLLC policy optimizer, according to an implementation;

FIG. 6 is a flow diagram illustrating an exemplary process for selecting an optimal URLLC policy to support a session;

FIG. 7 is a diagram illustrating example components of a device that may correspond to one or more of the devices illustrated and described herein; and

FIG. 8 is a diagram illustrating a use case for implementing dynamic policy selection for URLLC, according to an implementation.

### DETAILED DESCRIPTION OF EXAMPLE EMBODIMENTS

The following detailed description refers to the accompanying drawings. The same reference numbers in different drawings may identify the same or similar elements.

In 5G systems, Ultra-Reliable Low-Latency Communications (URLLC) support use cases that require high network reliability of more than 99.999%, and extremely low latency of approximately 1 millisecond (ms) for data transmission. Optimal network design for URLLC is particularly challenging because URLLC needs to satisfy these two conflicting requirements: ultra-high reliability and low latency. For best reliability, a mobile network uses more resources (e.g., re-transmission and redundancy of packets), which can increase latency. On the other hand, to minimize latency, the mobile network needs to use packets having a short frame structure without redundancy and retransmission, which can cause a severe degradation in reliability.

In addition to tradeoffs between latency and reliability, other critical factors must be monitored and evaluated, such as the number of antennas (i.e., multiple-input multiple output (MIMO) antennas) used at a serving base station for transmission power and available bandwidth in the system. Since emerging applications and/or services in 5G systems and future networks require URLLC, an optimal resource management policy that meets both ultra-high reliability and low latency requirements simultaneously is needed for mobile network operators.

Systems and methods described herein monitor network conditions and adaptively apply different resource management policies to support URLLC in Radio Access Networks (RANs), such as Fifth Generation New Radio (5G-NR) RANs. According to an implementation, a network device may store different resource management policy options for implementing communication sessions for a URLLC service level and may determine that the URLLC service level is required for a communication session (e.g., a packet data unit (PDU) session) requested by a user equipment (UE) device. The network device may select one of the different resource management policy options for the communication session based on a number of antennas used by an access station supporting the communication session and one of: an estimated available bandwidth for the access station or a transmission delay for processing a packet in the communication session. The network device may send, to an access station of the RAN, the selected one of the different resource management policy options.

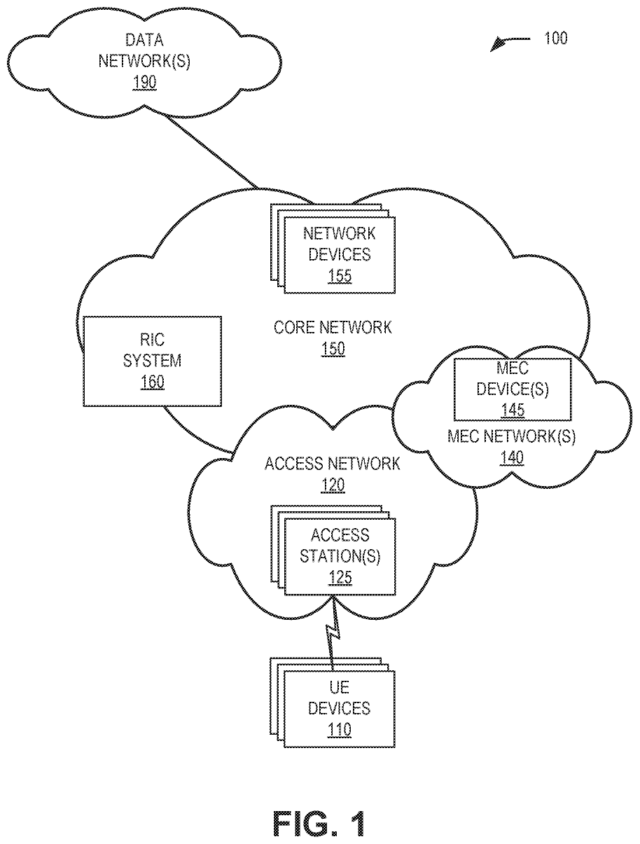

FIG. 1 is a diagram of an exemplary environment 100 in which the systems and/or methods, described herein, may be implemented. As shown in FIG. 1, environment 100 may include user equipment (UE) devices 110, an access network 120 that includes access stations 125, multi-access edge computing (MEC) network(s) 140 that include MEC device(s) 145, a core network 150 that includes network device(s) 155 and a RAN Intelligent Controller (RIC) system 160, and data networks 190.

UE device 110 may include a device with cellular wireless communication functionality. For example, UE device 110 may a handheld wireless communication device (e.g., a smart phone, etc.), a wearable computer device (e.g., a wristwatch computer device, etc.), a computer; a Wi-Fi access point, a portable gaming system, an Internet-of-Things device, a fixed wireless access (FWA) device, and/or any other type of computer device with wireless communication capabilities. UE device 110 may send packets to or over access network 120. UE device 110 may include/execute one or more applications. In some instances, these applications may have low-latency requirements (e.g., applicable for URLLC treatment) for communications with, for example, MEC devices 145 or data network 190. The latency requirements for an application may correspond to a particular user, flow, quality of service (QoS) and/or network slice associated with UE device 110.

Access network 120 may include a RAN that enables UE devices 110 to connect to core network 150 via access stations 125 using wireless signals. Access network 120 may include features associated with a 5G NR network and/or another advanced network, such as network slicing; carrier aggregation; advanced or massive multiple-input and multiple-output (MIMO) configurations (e.g., an 8×8 antenna configuration, a 16×16 antenna configuration, etc.); relay stations; Heterogeneous Networks (HetNets) of overlapping small cells and macrocells; Self-Organizing Network (SON) functionality; Machine-type Communications (MTC) functionality; and/or other types of 5G functionality.

Access station 125 may include a 5G NR base station (e.g., a gNodeB or gNB) and/or a Fourth Generation (4G) Long Term Evolution (LTE) base station (e.g., an eNodeB or eNB). Each access station 125 may include devices and/or components configured to enable wireless communication with UE devices 110. For example, access station 125 may include a radio frequency (RF) transceiver configured to communicate with UE devices 110 using a 5G NR air interface using a 5G NR protocol stack, a 4G LTE air interface using a 4G LTE protocol stack, and/or using another type of cellular air interface. Access station 125 may enable communication with core network 150 to enable core network 150 to authenticate UE device 110. According to one implementation, access station 125 may user a distributed configuration including central units (CUs), distributed units (DUs), and radio units (RUS) (not shown in FIG. 1).

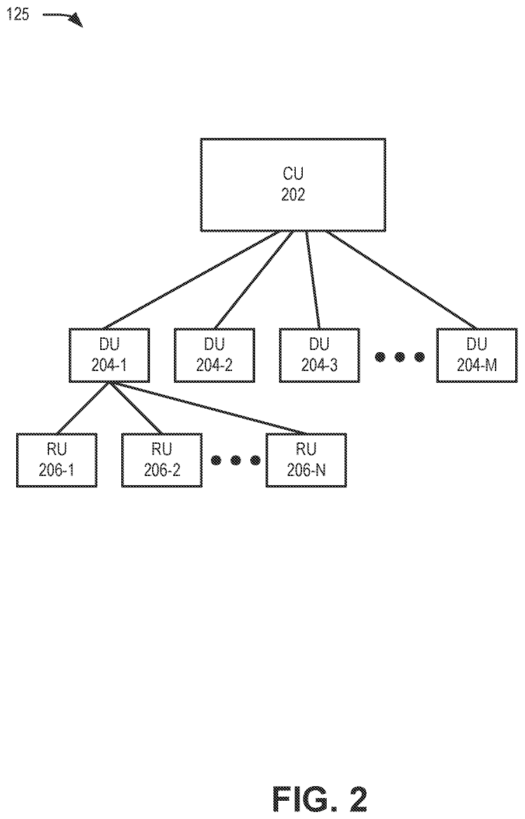

According to various implementations, access station 125 may include one or multiple sectors or antennas. The antennas may be implemented according to various configurations, such as single input single output (SISO), single input multiple output (SIMO), multiple input single output (MISO), MIMO, massive MIMO, three dimensional (3D) and adaptive beamforming (also known as full-dimensional agile MIMO), two dimensional (2D) beamforming, antenna spacing, tilt (relative to the ground), radiation pattern, directivity, elevation, planar arrays, and so forth. Depending on the implementation, access station 125 may provide a wireless access service at a cell, a sector, a sub-sector, carrier, and/or other configurable level. Access station 125 is described further in connection with FIG. 2.

Each MEC network 140 may be associated with one or more access stations 125 and may provide MEC services for UE devices 110 attached to the one or more access stations 125. MEC network 140 may be in proximity to the one or more access stations 125 from a geographic and network topology perspective, thus enabling low-latency communication with UE devices 110 and/or access stations 125. As an example, MEC network 140 may be located on a same site as one of the one or more access stations 125. As another example, MEC network 140 may be geographically closer to the one or more access stations 125, and reachable via fewer network nodes (or “hops”) and/or fewer switches, than other access stations 125 and/or data networks 190.

MEC network 140 may include one or more MEC devices 145 that may provide MEC services to UE devices 110, such as, for example, AR/VR, Vehicle-to-everything (V2X), location services, gaming, video analytics, data caching, optimized local content distribution, etc. In some implementations, MEC devices 145 may host deployed virtual network functions (VNFs) used to implement particular network slices, such as network slices designated for URLLC. Thus, MEC devices 145 may form part of an infrastructure for hosting network slices.

Core network 150 may be managed by a mobile network operator (MNO), such as a provider of cellular wireless communication services. Core network 150 may manage communication sessions of subscribers connecting to core network 150 via access network 120. For example, core network 150 may establish an Internet Protocol (IP) connection between UE devices 110 and MEC network 140/data network 190. In some implementations, core network 150 may include a 5G core network. A 5G core network may perform registration management, connection management, reachability management, mobility management, lawful intercepts, session management, session modification, session release, IP allocation and management, Dynamic Host Configuration Protocol (DHCP) functions, etc. In other implementations, core network 150 may also include 5G component combined with 4G LTE core network components (e.g., an evolved packet core (EPC) network).

Core network 150 may include network device(s) 155. A network device 155 may include a 5G network function; a 4G network node; a transport network device, such as, for example, a switch, router, firewall, gateway, an optical switching device (e.g., a reconfigurable optical add-drop multiplexer, etc.), and/or another type of network device. For example, network devices 155 may include a user plane function (UPF), an access and management mobility function (AMF), a session management function (SMF), a unified data management (UDM) device, a unified data repository (UDR) device, an authentication server function (AUSF), a Network Slice Selection Function (NSSF), a network repository function (NRF), a policy control function (PCF), a binding support function (BSF), a network data analytics function (NWDAF), a network exposure function (NEF), a lifecycle management (LCM) device, an application function (AF), a mobility management entity (MME), a packet gateway (PGW), an enhanced packet data gateway (ePDG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), and/or a charging system (CS). According to other exemplary implementations, network devices 155 may include additional, different, and/or fewer network devices than those described. For example, network devices 155 may include a non-standard or a proprietary network device, and/or another type of network device that may be well-known but not particularly mentioned herein.

Network devices 155 may also include a network device that provides a multi-RAT functionality (e.g., 4G and 5G, etc.), such as an SMF with PGW control plane functionality (e.g., SMF+PGW-C), a UPF with PGW user plane functionality (e.g., UPF+PGW-U), a service capability exposure function (SCEF) with a NEF (SCEF+NEF), and/or other combined nodes (e.g., an HSS with a UDM and/or UDR, an MME with an AMF, etc.). Network device 155 may include a physical function node or a VNF. Thus, the components of core network 150 may be implemented as dedicated hardware components and/or as VNFs implemented on top of a common shared physical infrastructure using software defined networking. Access network 120, MEC network 140, and core network 150 may also be collectively referred to herein as a transport network.

RIC system 160 may optimize radio resource management according to a performance metric requirement for an application service provided by MEC network 140 or other types of application service layer networks. The performance metric requirement may pertain, for example, to latency and reliability, such an URLLC requirements. RIC 160 may include a real-time RIC component to support real-time intelligent radio resource management. In other embodiments, RIC system 160 may also include a non-real time RIC component and/or a near-real time RIC component. The real-time RIC, near-real time RIC, and non-real time RIC may be implemented as functional layers of a single component (e.g., a single RIC device) or as separate components. For example, a non-real time RIC may be included in an orchestration layer of a network management system, while a real time RIC may be included within an access station 125.

RIC system 160 may control and optimize various radio resources of access stations 125 (e.g., radio unit (RU), gNB, eNB, etc.) associated with a 5G, 4G, or future RAN. For example, a real-time RIC component may control radio resource scheduling for uplink and downlink communication with UE device 110 and the associated latency and reliability requirements and application service. In one implementation, RIC system 160 may operate according to a time scale of less than about 1 second or another configurable time scale. In one embodiment, the real-time RIC component of RIC system 160 may manage the radio resources in view of latency and reliability (or another configured performance metric) in cooperation with near real-time artificial intelligence and/or machine learning. As described further herein, RIC system 160 may adaptively apply different resource management policies to support URLLC.

Data network 190 may include, and/or be connected to and enable communication with, a local area network (LAN), a wide area network (WAN), a metropolitan area network (MAN), an autonomous system (AS) on the Internet, an optical network, a cable television network, a satellite network, a wireless network (e.g., a Code Division Multiple Access (CDMA) network, a general packet radio service (GPRS) network, and/or an LTE network), an ad hoc network, a telephone network (e.g., the Public Switched Telephone Network (PSTN) or a cellular network), an intranet, or a combination of networks. Data network 190 may be associated with an Access Point Name (APN) and UE device 110 may request a connection to the particular data network 190 using the APN.

Although FIG. 1 shows exemplary components of environment 100, in other implementations, environment 100 may include fewer components, different components, differently arranged components, or additional components than depicted in FIG. 1. Additionally, or alternatively, one or more components of environment 100 may perform functions described as being performed by one or more other components of environment 100.

FIG. 2 is a diagram illustrating a configuration of access stations 125 in access network 120 consistent with environment 100, as described herein. As illustrated, access network 120 may include elements of a disaggregated RAN. The communication links and interfaces illustrated and described are exemplary in terms of number, connectivity, and type. The interfaces may be implemented as reference point-based or service-based. Each of access station 125 includes a CU 202, DUs 204-1 through 204-M, and, for each DU 204, one or more RUs 206-1 through 206-N. RU 206 may also be referred to as a remote radio head (RRH). For simplicity, other RUs are not shown in FIG. 2.

CUs 202 may control DUs 204 over a front haul interface. CUs 202 may manage, for example, sharing access network 120, conveying user data, mobility, sessions, etc. For each CU 202, there may be multiple DUs 204 controlled by the CU 202. CU 202 may process upper layers of the communication protocol stack for access stations 125. CUs 202 may not necessarily be physically located near DUs 204, and may be implemented as cloud computing elements, through network function virtualization (NFV) capabilities of the cloud. CU 202 may include protocol layers comprising, for example, a Radio Resource Control (RRC) layer and a Packet Data Convergence Protocol (PDCP) layer. In one implementation, CU 202 communicates with components of core network 150 through S1/NG interfaces and with other CUs 202 through X2/Xn interfaces.

DUs 204 may be controlled by CU 202. Each DU 204 in access network 120 may be controlled by one CU 202. However, each DU 204 may send signals to multiple RUs 206 for transmission. DUs 204 may handle UE device mobility, from DU to DU, from an access station 125 to another access station 125, from a cell to another cell, from a beam to another beam, etc. DU 204 may include protocol layers comprising a Radio Link Control (RLC) layer, a Media Access Control (MAC) layer, and a high Physical (PHY) layer. DUs 204 communicate with a CU 202 through an F1 interface and may process lower layers of a communication protocol stack for wireless station 110.

RU 206 may provide radio frequency (RF) functionality to establish wireless channels with UE devices 110. RU 206 may include protocol layers comprising a low PHY layer and an RF layer. The low PHY layer may receive signals from DU 204, process them, and send them to antenna elements of the RF layer for transmission. The RF layer may receive the signals and radiate the signals as beams that provide a coverage area for wireless service. RUs 206 may control beam shape, beam strength, and beam directions to balance traffic load over different bands. RU 206 may be embodied in different form factors having different sizes and various capabilities.

RIC system 160 may provide to access stations 125 instructions for timing (e.g., slot aggregation), bandwidth (e.g., carrier aggregation), and/or retransmissions (referred to collectively herein as “resource management policies”). RIC system 160 may dynamically select among different resource management policies to support consistent URLLC services.

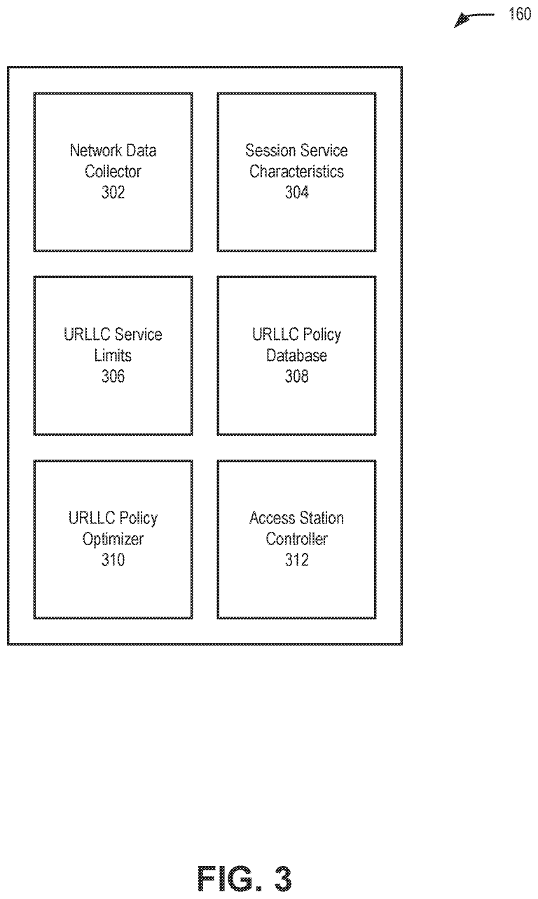

FIG. 3 is a block diagram illustrating example logical components of RIC system 160 that implements dynamic policy selection for URLLC. As shown in FIG. 3, RIC system 160 may include network data collector 302, session service characteristics 304, URLLC service limits 306, URLLC policy database 308, URLLC policy optimizer 310, and access station controller 312.

Network data collector 302 may obtain network data to determine a channel condition (e.g., for a physical channel supporting a URLLC network slice), such as data from access network 120, MEC network 140, and/or core network 150, that can be used to help determine dynamic policy selection for URLLC. Network data collector 302 may obtain actual and/or projected load levels, such as congestion levels and/or available bandwidth for individual cells/channels associated with an access station 125. For example, network data collector 302 may communicate with a self-organizing network (SON), a service orchestrator, and/or a network data analytics function (NWDAF) to obtain network data. In another implementation, network data collector 302 may communicate with MEC network 140 to obtain projected load levels. Network data collector 302 may also store data about an access station configuration, such as the number of antennas used at access station 125 or RU 206.

Session service characteristics 304 may identify requirements to support a session requesting a URLLC network slice. For example, session service characteristics 304 may identify the type of services requested for a particular session (e.g., graphic rendering, position projections, etc.). Based on the type of services, session service characteristics 304 may determine the expected processing delay a MEC device 145 may add to a round-trip communication and a minimum bandwidth required for such services. According to one implementation, session service characteristics 304 may communicate with MEC network 140 to obtain an expected delay to support requested services for a session using a URLLC network slice. According to another implementation, session service characteristics 304 may obtain session bandwidth requirements from session setup information provided by an application (e.g., an application being executed on UE device 110).

URLLC service limits 306 may include configurable limits and/or thresholds that can be used to help determine dynamic policy selection for URLLC. URLLC service limits 306 may include, for example, a threshold for the number of antennas (N_{T}, in any one cell) that determines at which number of antennas frequency diversity gain is significant or marginal. For example, an operator for the transport network may set the threshold number of antennas as 4<N_{T}<32, depending on the operators' requirements in the network. URLLC service limits 306 may also include, for example, a minimum delay requirement (Dₘᵢₙ) to support URLLC services. For example, an operator for the transport network may set the minimum delay requirement threshold (e.g., 1 ms), depending on requirements in the network.

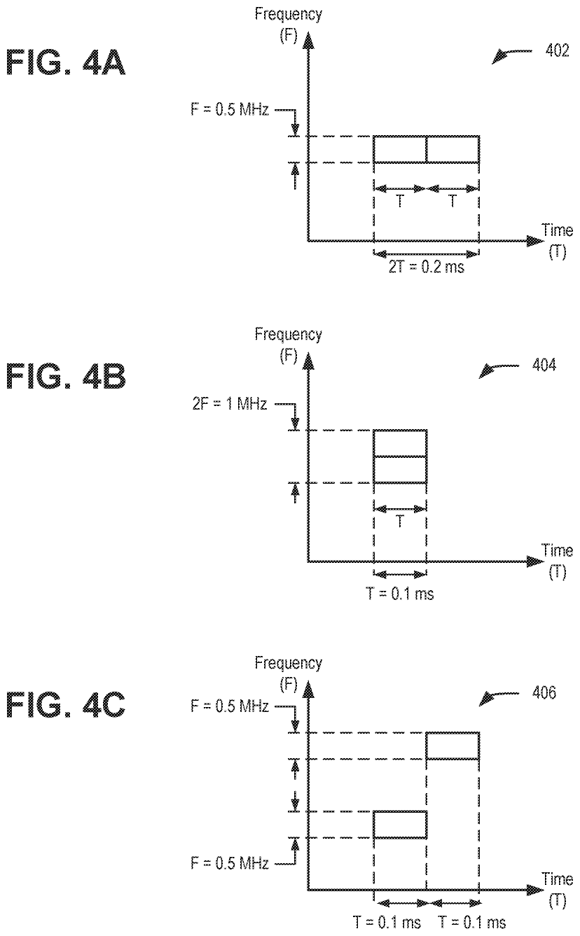

URLLC policy database 308 may store policy options for providing optimal resource management for URLLC. To meet the required minimum delays, URLLC services may use a short frame structure (e.g., 0.5 MHz) to reduce latency. The short frame structure also offers flexibility in resource management policy, providing policy options for retransmission or redundancy (i.e., adding longer duration in time, or larger bandwidth in frequency). According to an implementation, URLLC policy database 308 may store multiple different resource management policies (e.g., three or more) that may be implemented based on certain conditions. In one implementation, the three different resource management policies, referred to as a time policy, a bandwidth policy, and a retransmission with frequency hopping policy are described further in connection with FIGS. 4A-4C.

Referring to FIG. 4A, a schematic of a time policy is provided 402. The time policy (e.g., a slot aggregation policy or another time-based policy) may provide instructions for transmitting a packet with longer duration. An example time policy may direct transmitting a packet with longer duration in time (e.g., two frames, vice a single frame), as illustrated in schematic 402. For example, for a given channel condition, the time policy may reduce transmission error probability by increasing the transmission duration of a packet from 1 ms to 2 ms. The time policy increases reliability but may cause more delay with no additional bandwidth requirement.

Referring to FIG. 4B, a schematic of a bandwidth policy 404 is provided. The bandwidth policy (e.g., subcarrier aggregation or another bandwidth-based policy) may provide instructions for transmitting a packet with increased frequency band. An example bandwidth policy may direct transmitting a packet with increased bandwidth in a frequency band (e.g., from 0.5 MHz to 1 MHZ), as illustrated in schematic 404, where a packet size is F=0.5 MHz in frequency and T=0.1 ms in time. The bandwidth increase policy increases reliability, but it uses more bandwidth with no additional delay.

Referring to FIG. 4C, a schematic of a retransmission with frequency hopping policy 406 is provided. The retransmission with frequency hopping policy may provide instructions for transmitting a packet with frequency hopping over separate subchannels with different channel gains. The retransmission with frequency hopping policy increases reliability, but it has negative impacts on bandwidth and latency. The key advantage, however, is the frequency diversity gain, especially when the channel is in deep fading. Frequency-hopping is designed for robust operation in poor channel conditions (e.g., weak signal and/or noisy environments) by transmitting short packets at different frequencies across wide portions of channel bandwidth. The receiver correlates these signals against each other and selects the best signal for demodulation, which gives better performance compared with non-frequency hopping receivers operating under similar conditions.

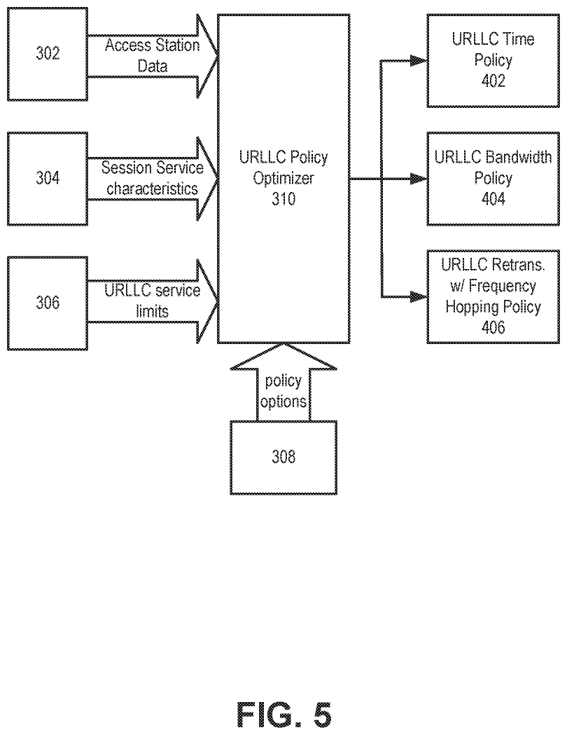

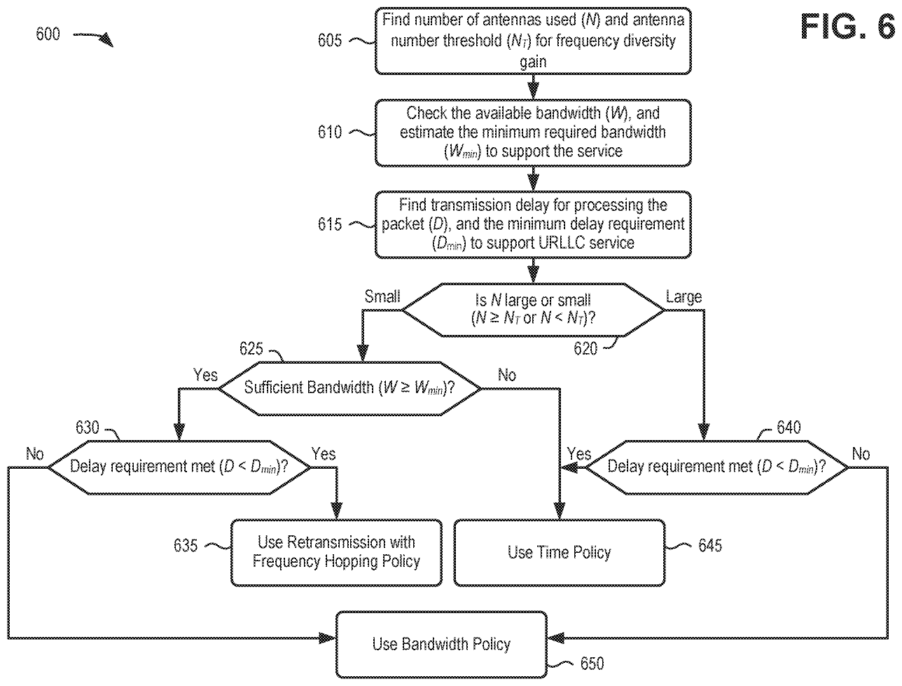

Referring back to FIG. 3, URLLC policy optimizer 310 may use data from network data collector 302, session service characteristics 304, URLLC service limits 306, and URLLC policy database 308 to perform dynamic policy selection for URLLC. More particularly, the policy optimizer 10 selects one of time policy 402, bandwidth policy 404, or retransmission with frequency hopping 406 to use for reliability improvement depending on the delay requirement, packet size, available bandwidth (W) on the channel, and required transmit power. The three policies have different transmit power requirements under changing conditions in the network. URLLC policy optimizer 310 may identify a resource management policy 402/404/406 that requires the least transmit power while meeting the requirements of reliability and latency. URLLC policy optimizer 310 is described further below in connection with FIGS. 5 and 6.

Access station controller 312 may assign policy options for providing optimal resource management for URLLC for a particular communication session or a type of communication session requested by a UE device 110. For example, when a session over a URLLC network slice is being established, access station controller 312 may receive instructions from URLLC policy optimizer 310 for implementing a resource management policy 402, 404, or 406.

Although FIG. 3 illustrates certain logical components of RIC system 160, in other implementations, RIC system 160 may include fewer, different, or additional logical components than depicted in FIG. 3. Additionally, or alternatively, one or more logical components of RIC system 160 may be performed by another device in network environment 100.

FIG. 5 is a diagram illustrating policy selection by URLLC policy optimizer 310. As shown in FIG. 5, URLLC policy optimizer 310 may receive access station data from network data collector 302 for an access station 125 or RU 206 serving a UE device 110. The access station data may include network loading levels and a number of available antennas.

Network loading may be expressed as an available bandwidth value, a capacity percentage, or a threshold indication (e.g., low, medium, high). In one implementation, network load values may be tracked by access station 125. In another implementation, network load values may be supplied to RIC 160, for example, by a NWDAF and updated in real time. In another implementation, network load values may include load projections obtained, for example, from a network data module (e.g., an NWDAF).

Because the MIMO technology is used in access stations 125 for advanced mobile networks, URLLC policy optimizer 310 may consider the number of antennas (N) being used to support a connection. If N is large, access station 125/RU 206 will have more transmit power and can thus avoid deep channel fading. Therefore, when N is large enough (e.g., greater than 32), the probability that the channel is in deep fading becomes quite small and the frequency diversity gain from the retransmission with frequency hopping policy 406 becomes negligible. Furthermore, retransmission with frequency hopping requires more transmit power. Thus, the case where N is large, URLLC policy optimizer 310 may determine to employ one of the redundancy policies, such as time policy 402 or frequency policy 404, depending on network conditions (as described further below in connection with FIG. 6). If N is small (e.g., less than 4 or 8), the frequency diversity gain from the retransmission with frequency hopping may become quite significant. In this case, the retransmission with frequency hopping requires less transmit power, and becomes an effective policy.

URLLC policy optimizer 310 may receive session service characteristics 304 for the requested session using URLLC. Session service characteristics 304 may include packet transmission delay times for a session packet. Packet transmission delay times may include a time value that includes the time to process and transmit a packet between endpoints. Packet transmission delay times may include, for example, actual packet transmission times or estimated times.

URLLC policy optimizer 310 may receive service limits 306 for the requested session using URLLC. Service limits 306 may include a minimum required bandwidth, a minimum delay requirement, and an antenna count threshold. Assuming the packet bandwidth size is 0.5 MHz (e.g., a URLLC standard), the minimum required bandwidth (Wₘᵢₙ) would be 0.5 MHz with no redundancy or 1 MHz with redundancy. The minimum delay requirement to support URLLC services (Dₘᵢₙ) may be a configured threshold value set by an MNO, such as 1 ms. The antenna count threshold may also be a configured threshold value set by an MNO to designate the number of antennas at which the frequency diversity gain is significant or marginal.

URLLC policy optimizer 310 may apply information from network data collector 302, session service characteristics 304, and service limits 306 to select an applicable policy from among policy options of URLLC policy database 308 (e.g., time policy 402, bandwidth policy 404, and retransmission with frequency hopping policy 406). As discussed previously, there is a tradeoff between latency and reliability. Higher reliability is achieved with retransmission or increase in time or increase frequency, but it causes higher latency and uses more bandwidth, resulting in degradation in quality of experience (QoE). URLLC policy optimizer 310 may monitor and then determine which policy to use, depending on the requirements and various scenarios. According to an implementation, URLLC policy optimizer 310 apply the decision process of FIG. 6.

FIG. 6 is a flow diagram illustrating an exemplary process 600 for selecting an optimal URLLC policy to support a session, according to an implementation described herein. In one implementation, process 600 may be implemented by RIC system 160. In another implementation, process 600 may be implemented by an access station 125, a UPF (e.g., a network device 155), or another device or combination of devices in network environment 100.

Process 600 may include identifying the number of antennas used and an antenna number threshold for frequency diversity gain (block 605). For example, RIC system 160 (e.g., URLLC policy optimizer 310) may retrieve the antenna number threshold (N_{T}) from service limits 306 and the number of antennas used by the access station (N) from network data collector 302.

Process 600 may further include checking the available bandwidth and estimating the minimum required bandwidth to support the URLLC service (block 610). For example, RIC system 160 may retrieve the minimum required bandwidth to support URLLC services (Wₘᵢₙ) from service limits 306 and the estimated available bandwidth (W) from network data collector 302.

Process 600 may also include identifying the transmission delay for processing the packet, and the minimum delay requirement to support the URLLC service (block 615). For example, RIC system 160 may retrieve the transmission delay (D) from session service characteristics 304 and the minimum delay requirement (Dₘᵢₙ) from service limits 306.

At process block 620, the number of antennas may be compared to the antenna threshold. For example, RIC system 160 may determine if the antenna count, N, at access station 125 is small (below the antenna threshold, N_{T}) or large (e.g., equal to or above the antenna threshold, N_{T}). If N is small (block 620—small), process 600 may include determining if there is sufficient bandwidth (block 625). For example, if N is small (e.g., N<N_{T}), the frequency diversity gain from the retransmission with frequency hopping may be significant. In this case, the retransmission with frequency hopping policy 406, which provides the frequency diversity gain, may be the best policy option, if the delay and bandwidth requirements can be met. Thus, RIC system 160 may compare the available bandwidth W at access station 125 against the minimum required bandwidth Wₘᵢₙ.

If there is sufficient bandwidth (block 625—Yes), process block 630 may include determining if the delay requirement can be met (block 630). For example, if W≥Wₘᵢₙ, RIC system 160 may compare the transmission delay (D) to the minimum delay requirement (Dₘᵢₙ).

If the delay requirement can be met (block 630—Yes), process 600 may include selecting the retransmission with frequency hopping policy (block 635). For example, if D<Dₘᵢₙ, RIC system 160 may select retransmission with frequency hopping policy 406.

If N is large (block 620—large), process 600 may include determining if the delay requirement can be met (block 640). For example, if N≥N_{T}, similar to block 630, RIC system 160 may compare the transmission delay (D) to the minimum delay requirement (Dₘᵢₙ).

If there is not sufficient bandwidth for a small antenna count (block 635—no) or if the delay requirement can be met for a large antenna count (block 640—Yes), process 600 may include selecting the time policy (block 645). For example, RIC system 160 may select time policy 402.

If the delay requirement cannot be met for a small antenna count (block 630—No) or if the delay requirement cannot be met for a large antenna count (block 640—No), process 600 may include selecting the bandwidth policy (block 650). For example, RIC system 160 may select bandwidth policy 404.

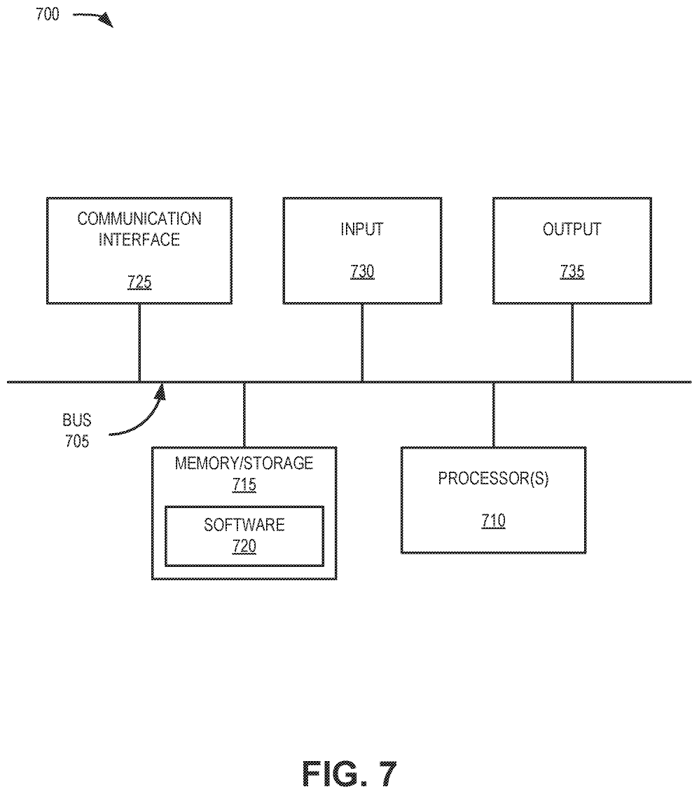

FIG. 7 is a diagram illustrating exemplary components of a device 700 that may correspond to one or more of the devices described herein. For example, device 700 may correspond to components included in UE device 110, access stations 125, MEC devices 145, network devices 155, RIC system 160, and other devices illustrated in FIGS. 1 and 2. As illustrated in FIG. 7, according to an exemplary embodiment, device 700 includes a bus 705, processor 710, memory/storage 715 that stores software 720, a communication interface 725, an input 730, and an output 735. According to other embodiments, device 700 may include fewer components, additional components, different components, and/or a different arrangement of components than those illustrated in FIG. 7 and described herein.

Bus 705 includes a path that permits communication among the components of device 700. For example, bus 705 may include a system bus, an address bus, a data bus, and/or a control bus. Bus 705 may also include bus drivers, bus arbiters, bus interfaces, and/or clocks.

Processor 710 includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Processor 710 may be implemented as hardware (e.g., a microprocessor, etc.), a combination of hardware and software (e.g., a SoC, an ASIC, etc.), may include one or multiple memories (e.g., cache, etc.), etc. Processor 710 may be a dedicated component or a non-dedicated component (e.g., a shared resource).

Processor 710 may control the overall operation or a portion of operations performed by device 700. Processor 710 may perform operations based on an operating system and/or various applications or computer programs (e.g., software 720). Processor 710 may access instructions from memory/storage 715, from other components of device 700, and/or from a source external to device 700 (e.g., a network, another device, etc.). Processor 710 may perform an operation and/or a process based on various techniques including, for example, multithreading, parallel processing, pipelining, interleaving, etc.

Memory/storage 715 includes one or multiple memories and/or one or multiple other types of storage mediums. For example, memory/storage 715 may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory (e.g., a NAND flash, a NOR flash, etc.), and/or some other type of memory. Memory/storage 715 may include a hard disk (e.g., a magnetic disk, an optical disk, a magneto-optic disk, a solid state disk, etc.), a Micro-Electromechanical System (MEMS)-based storage medium, and/or a nanotechnology-based storage medium. Memory/storage 715 may include a drive for reading from and writing to the storage medium.

Memory/storage 715 may be external to and/or removable from device 700, such as, for example, a Universal Serial Bus (USB) memory stick, a dongle, a hard disk, mass storage, off-line storage, network attached storage, or some other type of storage medium. Memory/storage 715 may store data, software, and/or instructions related to the operation of device 700.

Software 720 includes an application or a program that provides a function and/or a process. Software 720 may include an operating system. Software 720 is also intended to include firmware, middleware, microcode, hardware description language (HDL), and/or other forms of instruction. For example, according to an implementation, software 720 may implement portions of logical components of FIG. 3.

Communication interface 725 permits device 700 to communicate with other devices, networks, systems, devices, and/or the like. Communication interface 725 includes one or multiple wireless interfaces and/or wired interfaces. For example, communication interface 725 may include one or multiple transmitters and receivers, or transceivers. Communication interface 725 may include one or more antennas. For example, communication interface 725 may include an array of antennas. Communication interface 725 may operate according to a protocol stack and a communication standard. Communication interface 725 may include various processing logic or circuitry (e.g., multiplexing/de-multiplexing, filtering, amplifying, converting, error correction, etc.).

Input 730 permits an input into device 700. For example, input 730 may include a keyboard, a mouse, a display, a button, a switch, an input port, speech recognition logic, a biometric mechanism, a microphone, a visual and/or audio capturing device (e.g., a camera, etc.), and/or some other type of visual, auditory, tactile, etc., input component. Output 735 permits an output from device 700. For example, output 735 may include a speaker, a display, a light, an output port, and/or some other type of visual, auditory, tactile, etc., output component. According to some embodiments, input 730 and/or output 735 may be a device that is attachable to and removable from device 700.

Device 700 may perform a process and/or a function, as described herein, in response to processor 710 executing software 720 in a computer-readable medium, such as memory/storage 715. A computer-readable medium may be defined as a non-transitory memory device. A memory device may be implemented within a single physical memory device or spread across multiple physical memory devices. By way of example, instructions may be read into memory/storage 715 from another memory/storage 715 (not shown) or read from another device (not shown) via communication interface 725. The instructions stored by memory/storage 715 cause processor 710 to perform a process described herein. Alternatively, for example, according to other implementations, device 700 performs a process described herein based on the execution of hardware (processor 710, etc.).

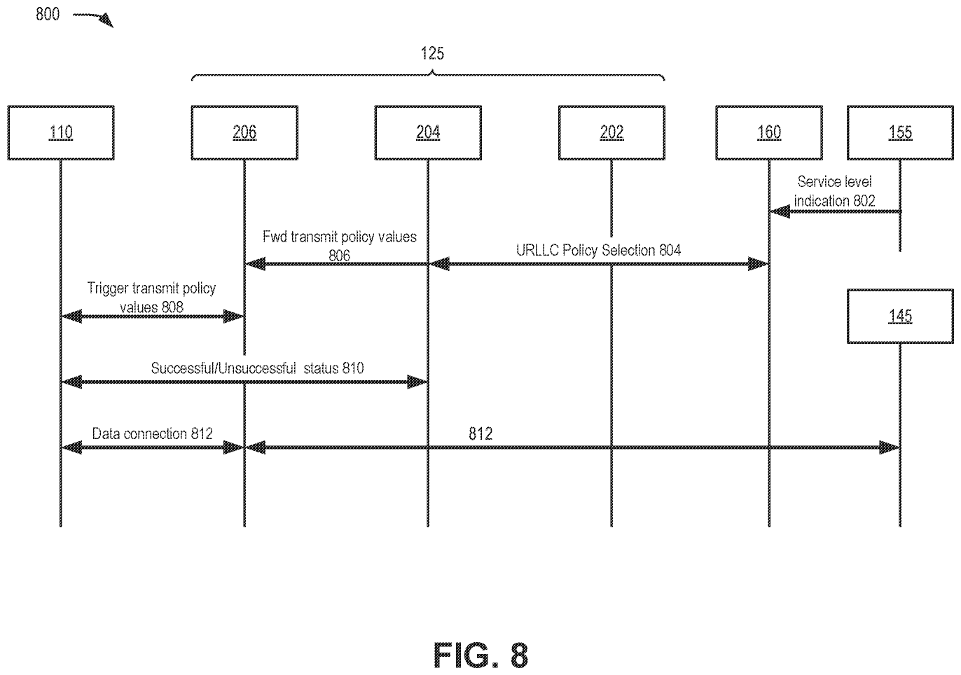

FIG. 8 is a diagram illustrating a use case for implementing dynamic policy selection for URLLC in a portion 800 of network environment 100. FIG. 8 provides simplified illustrations of communications in network portion 800 and are not intended to reflect every signal or communication exchanged between devices/functions. As shown in FIG. 8, network portion 800 may include UE device 110, RU 206, DU 204, CU 202, network device 155, RIC system 160, and MEC device 145.

RIC system 160 may receive a service level indication 802 from one of network devices 155. The service level indication may include, for example, a QoS Class Identifier (QCI), a network slice ID, or another direct or indirect service level requirement for an application of UE device 110. In the example of FIG. 8, service level indication 802 may include a URLLC service level requirement for UE device 110.

In response to service level indication 802, RIC system 160 may select and provide a resource management policy 804 to DU 204 (e.g., the particular DU managing the communication session for UE device 110) via CU 202. As described above in connection with FIGS. 4A-4C, the resource management policy 804 may include instructions for timing (e.g., slot aggregation), bandwidth (e.g., carrier aggregation), and/or retransmissions to optimally meet URLLC service levels. DU 204 may, in turn, communicate particular transmission policy values 806 for slot aggregation, carrier aggregation, and/or retransmission with frequency hopping to RU 206.

As indicated at reference 808, RU 206 may trigger use of transmit policy values by UE device 110. As indicated at reference 810, UE device 110 and access station 125 may conduct signaling to confirm a successful data packet transmission. Assuming a successful transmission, UE device 110 may then, as shown in reference 812, establish a connection with MEC device 145 directly through access device 125 (e.g., without using core network 150), using the assigned policy.

URLLC service levels require ultra-high reliability (e.g., better than 10-3 packet loss probability) and very stringent latency (e.g., 1 ms) for new emerging applications or services. According to implementations described herein, to support URLLC, different policy options are adopted for resource management: a bandwidth policy, a time policy, and a retransmission with frequency hopping policy. Systems and methods described herein are designed to use the best policy option under various conditions in order to provide energy efficiency (e.g., the least amount of required transmit power), very low latency, and high reliability.

The foregoing description of implementations provides illustration and description, but is not intended to be exhaustive or to limit the invention to the precise form disclosed. Modifications and variations are possible in light of the above teachings or may be acquired from practice of the invention. For example, while a series of blocks have been described with regard to FIG. 6, and message/operation flows with respect to FIG. 8, the order of the blocks and message/operation flows may be modified in other embodiments. Further, non-dependent blocks may be performed in parallel.

Certain features described above may be implemented as “logic” or a “unit” that performs one or more functions. This logic or unit may include hardware, such as one or more processors, microprocessors, application specific integrated circuits, or field programmable gate arrays, software, or a combination of hardware and software.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
storing, by a network device, a plurality of resource management policy options for implementing communication sessions for an Ultra-Reliable Low-Latency Communications (URLLC) service level;
determining, by the network device, that the URLLC service level is required for a communication session requested by a user equipment (UE) device;
selecting, by the network device, one of the resource management policy options for the communication session based on a number of antennas used by an access station supporting the communication session and one of:
an estimated available bandwidth for the access station, or
a transmission delay for processing a packet in the communication session; and
sending, by the network device and to the access station, the selected one of the resource management policy options.

2. The method of claim 1, wherein selecting the one of the resource management policy options further comprises:
identifying an antenna count threshold and the number of antennas used by the access station supporting the communication session; and
comparing the number of antennas used by the access station to the antenna count threshold.

3. The method of claim 2, wherein the antenna count threshold is a number between 4 and 32.

4. The method of claim 2, further comprising:
determining, by the network device, a minimum required bandwidth for a URLLC communication session and the estimated available bandwidth for the access station; and
determining, by the network device, a minimum delay requirement for the communication session and the transmission delay for processing a packet in the communication session.

5. The method of claim 1, wherein the resource management policy options include:
a time-based policy,
a bandwidth-based policy, and
a retransmission with frequency hopping policy.

6. The method of claim 5, wherein the time policy includes:
instructions for increasing a transmission duration for a packet to at least two frames of a first URLLC frame.

7. The method of claim 5, wherein the bandwidth policy includes:
instructions for increasing a bandwidth in frequency band to at least double a first URLLC bandwidth.

8. The method of claim 5, wherein the retransmission with frequency hopping policy includes:
instructions for retransmitting packets with frequency hopping over separate subchannels.

9. The method of claim 1, wherein the network device includes a Radio Access Network (RAN) intelligent controller.

10. A network device, comprising:
one or more processors configured to:
store a plurality of resource management policy options for implementing communication sessions for an Ultra-Reliable Low-Latency Communications (URLLC) service level;
determine that the URLLC service level is required for a communication session requested by a user equipment (UE) device;
select one of the resource management policy options for the communication session based on a number of antennas used by an access station supporting the communication session and one of:
an estimated available bandwidth for the access station, or
a transmission delay for processing a packet in the communication session; and
send, to the access station, the selected one of the resource management policy options.

11. The network device of claim 10, wherein the network device includes a RAN intelligent controller.

12. The network device of claim 10, wherein, when selecting the one of the resource management policy options, the one or more processors are further configured to:
identify an antenna count threshold and the number of antennas used by the access station supporting the communication session; and
compare the number of antennas used by the access station to the antenna count threshold.

13. The network device of claim 12, wherein the one or more processors are further configured to:
determine a minimum required bandwidth for a URLLC communication session and the estimated available bandwidth for the access station; and
determine a minimum delay requirement for the communication session and the transmission delay for processing a packet in the communication session.

14. The network device of claim 10, wherein the resource management policy options include:
a time policy,
a bandwidth policy, and
a retransmission with frequency hopping policy.

15. The network device of claim 14, wherein the retransmission with frequency hopping policy includes:
instructions for retransmitting packets with frequency hopping over separate subchannels.

16. The network device of claim 14, wherein the time policy includes:
instructions for increasing a transmission duration for a packet to at least two frames.

17. The network device of claim 14, wherein the bandwidth policy includes:
instructions for increasing a bandwidth in frequency band to at least double a first URLLC bandwidth.

18. A non-transitory computer-readable medium containing instructions, executable by at least one processor of a network device, for:
storing resource management policy options for implementing communication sessions for an Ultra-Reliable Low-Latency Communications (URLLC) service level;
determining that the URLLC service level is required for a communication session requested by a user equipment (UE) device;
selecting one of the resource management policy options for the communication session based on a number of antennas used by an access station supporting the communication session and one of:
an estimated available bandwidth for the access station, or
a transmission delay for processing a packet in the communication session; and
sending, to the access station, the selected one of the resource management policy options.

19. The non-transitory computer-readable medium of claim 18, wherein the instructions for selecting the one of the resource management policy options further comprises instructions for:
identifying an antenna count threshold and the number of antennas used by the access station supporting the communication session; and
comparing the number of antennas used by the access station to the antenna count threshold.

20. The non-transitory computer-readable medium of claim 19, wherein the instructions for selecting the one of the resource management policy options further comprises instructions for:
selecting, among one of a time-based policy, a bandwidth-based policy, and a retransmission with frequency hopping policy.
